(19) United States
(12) Patent Application Publication
(10) Pub. No.: US 2007/0274255 A1
(43) Pub. Date: Nov. 29, 2007

(54) MOBILE NODE, NETWORK SYSTEM, AND NETWORK ROAMING METHOD

(75) Inventors: Wei-huai Hung, Tu-Cheng (TW); Jyh-cheng Chen, Tu-Cheng (TW); Ching-yuan YU, Tu-Cheng (TW); Shao-hsiu Hung, Tu-Cheng (TW); Fu-cheng Chen, Tu-Cheng (TW); Meng-hui Ou, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HON HAI PRECISION INDUSTRY CO., LTD., Tu-Cheng,Taipei Hsien (TW); NATIONAL TSING-HUA UNIVERSITY, Hsinchu (TW)

(21) Appl. No.: 11/752,312

(22) Filed: May 23, 2007

(30) Foreign Application Priority Data
May 26, 2006 (TW) 95118787

(51) Int. Cl. H04Q 7/00

(52) U.S. Cl. 370/328

(57) ABSTRACT

A mobile node (10) roams from a home network to a foreign network, and comprises an address detection module (101) and an address conversion request module (107). The address detection module detects a current address of the mobile node. The address conversion request module transmits an address conversion request message to a home agent according to the current address of the mobile node and an address of the home agent, receives an address conversion response message from the home agent, and generates an address mapping relationship between a home address and the current address of the mobile node. A network system and a network roaming method are also provided.

### BACKGROUND OF THE INVENTION

1. Field of the Invention

The invention relates to network communications, and particularly to a mobile node, a network system, and a network roaming method.

2. Description of Related Art

Owing to limited addresses of Internet protocol version 4 (IPv4), IP version 6 (IPv6) becomes the next generation protocol designed by the Internet Engineering Task Force (IETF) to replace IPv4. During the transition period from IPv4 to IPv6, IPv4 and IPv6 are co-existent.

However, existing mobile systems either comply with IPv4 or IPv6, and do not support roaming between the two networks. Therefore, what is expected is to achieve a mobile system that supports roaming between IPv4 and IPv6 networks.

### SUMMARY OF THE INVENTION

One aspect of the present invention provides a mobile node roaming from a home network to a foreign network. The mobile node includes an address detection module and an address conversion request module. The address detection module detects a current address of the mobile node. The address conversion request module transmits an address conversion request message to a home agent according to the current address of the mobile node and an address of the home agent, receives an address conversion response message from the home agent, and generates an address mapping relationship between a home address and the current address of the mobile node according to the address conversion response message.

Another aspect of the present invention provides a network system. The network system includes a home agent and a mobile node. The mobile node roams from a home network to a foreign network, and includes an address detection module and an address conversion request module. The address detection module detects a current address of the mobile node. The address conversion request module transmits an address conversion request message to a home agent according to the current address of the mobile node and an address of the home agent, receives an address conversion response message from the home agent, and generates an address mapping relationship between a home address and the current address of the mobile node. The home agent includes an address conversion response module. The address conversion response module receives the address conversion request message from the mobile node, transmits the address conversion response message to the mobile node, and generates the address mapping relationship between the home address and the current address of the mobile node according to the address conversion request message.

Another aspect of the present invention provides a network roaming method used for a mobile node roaming from a home network to a foreign network. The network roaming method includes: detecting a current address of the mobile node; transmitting an address conversion request message from the mobile node to a home agent according to the current address of the mobile node and an address of the home agent; receiving an address conversion response message from the home agent; and generating an address mapping relationship between a home address and the current address of the mobile node according to the address conversion response message.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic diagram of an application environment of an exemplary embodiment of the present invention;

FIG. 2 is a schematic diagram of functional modules of a mobile node of an exemplary embodiment of the present invention;

FIG. 3 is a transport diagram of a network roaming method of an exemplary embodiment of the present invention;

FIG. 4 is a transport diagram of a network roaming method of another exemplary embodiment of the present invention;

FIG. 5 is a schematic diagram of functional modules of a home agent of an exemplary embodiment of the present invention;

FIG. 6 is a schematic diagram of a message of an exemplary embodiment of the present invention;

FIG. 7 is a schematic diagram of an encapsulated message of an exemplary embodiment of the present invention;

FIG. 8 is a flowchart of a network roaming method of an exemplary embodiment of the present invention;

FIG. 9 is a flowchart after a node A of FIG. 8;

FIG. 10 is a detailed flowchart of step S817 of FIG. 8;

FIG. 11 is a detailed flowchart of step S907 of FIG. 9;

FIG. 12 is a flowchart showing a method for forwarding messages by a home agent of an exemplary embodiment of the present invention;

FIG. 13 is a detailed flowchart of the method of FIG. 12;

FIG. 14 is a detailed flowchart of step S1309 of FIG. 13 when a foreign network is an IPv4 network; and

FIG. 15 is a detailed flowchart of step S1309 of FIG. 13 when a foreign network is an IPv6 network.

### DETAILED DESCRIPTION OF THE INVENTION

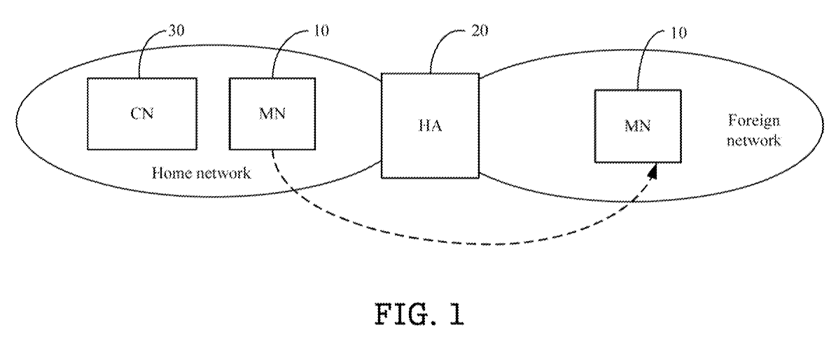

FIG. 1 is a schematic diagram of an application environment of an exemplary embodiment of the present invention. In the exemplary embodiment, a network system includes a mobile node (MN) 10, a home agent (HA) 20, and a correspondent node (CN) 30. The MN 10 can roam from a home network to a foreign network. The home network may be an IPv4 or IPv6 network, and the foreign network may be an IPv6 or IPv4 network. When the MN 10 and the CN 30 are both in the home network, the MN 10 communicates with the CN 30 directly based on IPv4 or IPv6. When the MN 10 is in the foreign network and the CN 30 is in the home network, the MN 10 communicates with the CN 30 via the HA 20. In the exemplary embodiment, the CN 30 may be a network server, a mobile phone, or another network device.

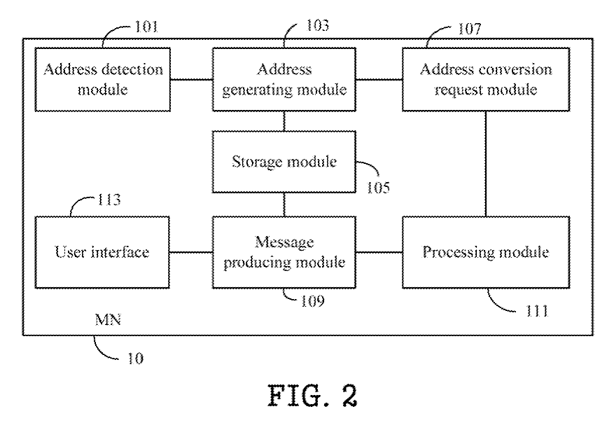

FIG. 2 is a schematic diagram of functional modules of the MN 10 of an exemplary embodiment of the present invention. In the exemplary embodiment, the MN 10 includes an address detection module 101, an address generating module 103, a storage module 105, an address conversion request module 107, a message producing module 109, a processing module 111, and a user interface 113.

The storage module 105 stores a home address of the MN 10 (MN_{HoA}), an address of the HA 20, and an address of the CN 30. In the exemplary embodiment, the address of the home agent 20 includes an IPv4 address (HA₄), and an IPv6 address (HA₆).

The address detection module 101 detects a current address of the MN 10, and determines whether the MN 10 is roaming by comparing the current address of the MN 10 and the home address of the MN 10. If the current address is the same as the home address of the MN 10, the address detection module 101 determines that the MN 10 is not roaming. If the current address of the MN 10 is different from the home address of the MN 10, the address detection module 101 determines that the MN 10 is roaming. In the exemplary embodiment, when the MN 10 roams from the home network to the foreign network, the address detection module 101 detects the current address of the MN 10 from the foreign network, and determines that the MN 10 roams to the foreign network according to the current address thereof. If the foreign network is an IPv4 network, the current address of the MN 10 is an IPv4 care-of address (CoA) (MN_{CoA4}). If the foreign network is an IPv6 network, the current address of the MN 10 is an IPv6 CoA (MN_{CoA6}). In this embodiment, the IPv4/IPv6 CoAs are temporary IPv4/IPv6 addresses for the MN 10 that enables message delivery when the MN 10 is connecting from the foreign network.

The address generating module 103 generates an IPv6 CoA of the MN 10 according to the current address of the MN 10 when the MN 10 roams to an IPv4 network. In the exemplary embodiment, the address generating module 103 generates the IPv6 CoA of the MN 10 according to the IPv4 CoA of the MN 10 detected by the address detection module 101 by use of an address conversion mechanism. In this embodiment, the address conversion mechanism may be a 6 to 4 automatic tunnel, a network address translation-protocol translation (NAT-PT) and so on.

The address conversion request module 107 generates an address conversion request message according to the current address of the MN 10 and the address of the HA 20, transmits the address conversion request message to the HA 20, receives an address conversion response message from the HA 20, and generates an address mapping relationship between the home address and the current address of the MN 10 according to the address conversion response message.

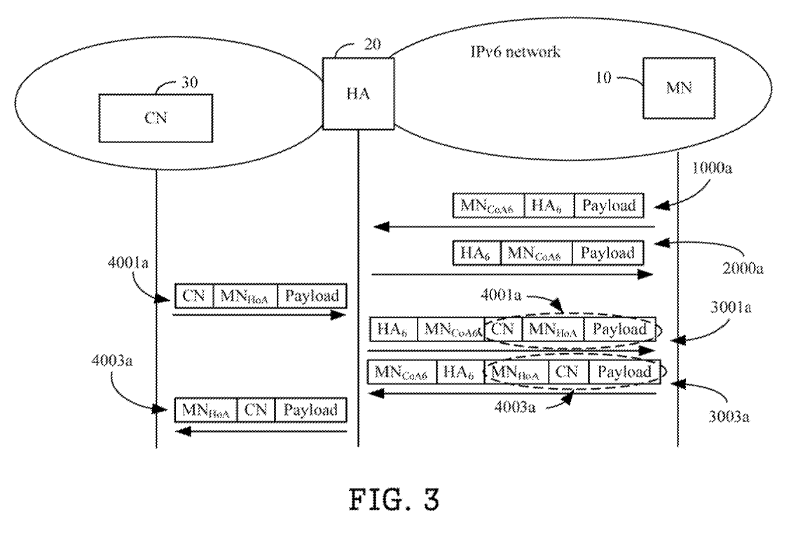

For example, referring also to FIG. 3, if the MN 10 roams from the home network to an IPv6 network, the address conversion request module 107 generates an address conversion request message 1000a according to the current address of the MN 10, namely the IPv6 CoA of the MN 10 (MN_{CoA6}), and the IPv6 address of the HA 20 (HA₆), and then transmits the address conversion request message 1000a to the HA 20, and then receives an address conversion response message 2000a from the HA 20, and then generates an address mapping relationship between the home address and the IPv6 CoA of the MN 10 according to the address conversion response message 2000a.

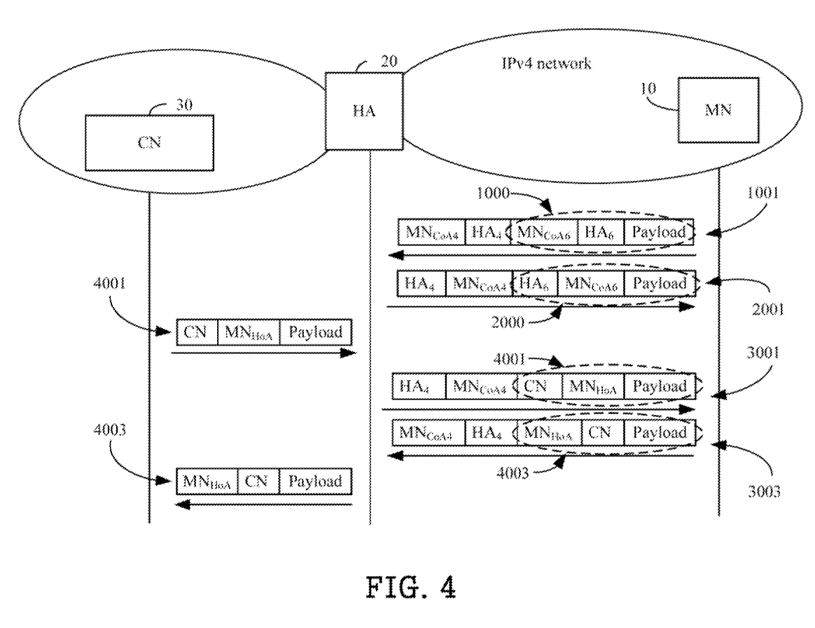

Referring to FIG. 4, if the MN 10 roams from the home network to an IPv4 network, the address conversion request module 107 generates an address conversion request message 1000 according to the current address of the MN 10, namely the IPv6 CoA of the MN 10 (MN_{CoA6}), and the IPv6 address of the HA 20 (HA₆), and then encapsulates the address conversion request message 1000 in an IPv4 tunnel with endpoints of the IPv4 CoA of the MN 10 (MN_{CoA4}) and the IPv4 address of the HA 20 (HA₄) to produce an encapsulated address conversion request message 1001. Then, the address conversion request module 107 transmits the encapsulated address conversion request message 1001 to the HA 20, and receives an encapsulated address conversion response message 2001 from the HA 20. Afterwards, the address conversion request module 107 generates an address mapping relationship between the home address and the IPv4 CoA of the MN 10 according to the encapsulated address conversion response message 2001.

Referring to FIG. 2 again, the message producing module 109 produces an origination message destined for the CN 30. In the exemplary embodiment, the message producing module 109 receives user information via the user interface 113, and produces the origination message according to the user information, the home address of the MN 10, and the address of CN 30, and then transmits the origination message to the processing module 111. The processing module 111 processes the origination message according to the address mapping relationship.

In detail, if the MN 10 roams to an IPv6 network, referring also to FIG. 3, the message producing module 109 produces an origination message 4003a, and then the processing module 111 encapsulates the origination message 4003a in an IPv6 tunnel with endpoints of the IPv6 CoA of the MN 10 (MN_{CoA6}) and the IPv6 address of the HA 20 (HA₆) to produce an encapsulated origination message 3003a, and then transmits the encapsulated origination message 3003a to the HA 20.

If the MN 10 roams to an IPv4 network, referring to FIG. 4, the message producing module 109 produces an origination message 4003, and then the processing module 111 encapsulates the origination message 4003 in an IPv4 tunnel with endpoints of the IPv4 CoA of the MN 10 (MN_{CoA4}) and the IPv4 address of the HA 20 (HA₄) to produce an encapsulated origination message 3003, and then transmits the encapsulated origination message 3003 to the HA 20.

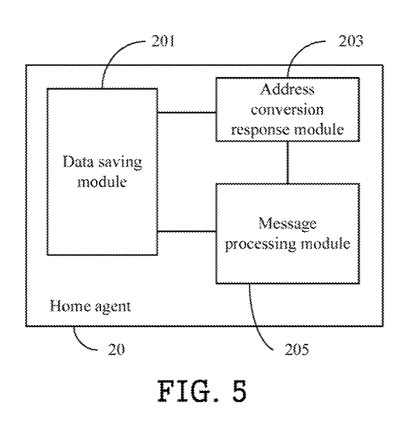

FIG. 5 is a schematic diagram of functional modules of the HA 20 of an exemplary embodiment of the present invention. The HA 20 includes a data saving module 201, an address conversion response module 203, and a message processing module 205.

The data saving module 201 saves the address of the HA 20. In the exemplary embodiment, the address of the HA 20 includes the IPv4 address and the IPv6 address. The address conversion response module 203 receives the address conversion request message from the MN 10, and generates the address conversion response message according to the address conversion request message, transmits the address conversion response message to the MN 10, and generates an address mapping relationship between the home address and the current address of the MN 10 according to the address conversion request message.

In the exemplary embodiment, if the address conversion request message is encapsulated in an IPv4 tunnel, the address conversion response module 203 also transmits the address conversion response message encapsulated in the IPv4 tunnel to the MN 10. For example, referring to FIG. 4, the address conversion request message 1000 is encapsulated in an IPv4 tunnel, the address conversion response module 203 encapsulates the address conversion response message 2000 in the IPv4 tunnel to produce an encapsulated address conversion response message 2001, and transmits the encapsulated address conversion response message 2001 to the MN 10. The address conversion response module 203 generates the address mapping relationship according to the IPv4 CoA, the IPv6 CoA, and the home address of the MN 10.

Referring also to FIG. 3, if the address conversion request message 1000a is based on an IPv6 format, the address conversion response module 203 transmits the address conversion response message 2000a also based on the IPv6 format to the MN 10. Simultaneously, the address conversion response module 203 generates an address mapping relationship according to the IPv6 CoA and the home address of the MN 10.

The message processing module 205 processes messages according to the address mapping relationship generated by the address conversion response module 203. In the exemplary embodiment, the message processing module 205 receives an origination message destined for the MN 10 from the CN 30, and processes the origination message according to the address mapping relationship, and then transmits the processed origination message to the MN 10.

For example, referring to FIG. 4, if the MN 10 roams to an IPv4 network, and the CN 30 transmits an origination message 4001 destined for the MN 10 to the HA 20, the message processing module 205 of the HA 20 receives the origination message 4001 from the CN 30, and then encapsulates the origination message 4001 in an IPv4 tunnel with endpoints of the IPv4 CoA of the MN 10 (MN_{CoA4}) and the IPv4 address of the HA 20 (HA₄) according to the address mapping relationship to produce an encapsulated origination message 3001, and then transmits the encapsulated origination message 3001 to the MN 10.

If the HA 20 receives an encapsulated origination message 3003 destined for the CN 30 from the MN 10, the message processing module 205 decapsulates the encapsulated origination message 3003 according to the address mapping relationship to obtain an origination message 4003, and then transmits the origination message 4003 to the CN 30.

Referring to FIG. 3, if the MN 10 roams to an IPv6 network, and the message processing module 205 receives an origination message 4001a destined for the MN 10 from the CN 30, the message processing module 205 then encapsulates the origination message 4001a in an IPv6 tunnel with endpoints of IPv6 CoA address of the MN 10 (MN_{CoA6}) and the IPv6 address of the HA 20 (HA₆) according to the address mapping relationship to produce an encapsulated origination message 3001a, and then transmits the encapsulated origination message 3001a to the MN 10.

If the HA 20 receives an encapsulated origination message 3003a destined for the CN 30 from the MN 10, the message processing module 205 decapsulates the encapsulated origination message 3003a according to the address mapping relationship to obtain an origination message 4003a, and then transmits the origination message 4003a to the CN 30.

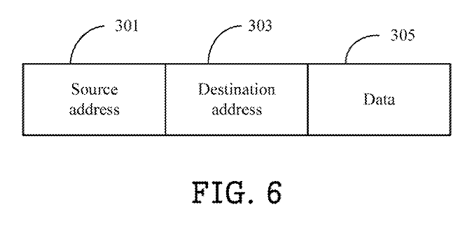

FIG. 6 is a schematic diagram of a message of an exemplary embodiment of the present invention. In the exemplary embodiment, the message may be an address conversion request message, an address conversion response message, or an origination message. The address conversion request message, the address conversion response message, and the origination message may all be packets. The message includes a source address field 301, a destination address field 303, and a data field 305. The source address field 301 indicates a source address of the message. The destination address field 303 indicates a destination address of the message. The data field 305 carries a payload of the message. In this embodiment, if the message is the address conversion request message or the address response message, the source address field 301 and the destination address field 303 are both set as IPv6 addresses.

If the message is the origination message, the source address field 301 and the destination address field 303 may be respectively set as the home address of the MN 10 and the address of the CN 30, or the address of the CN 30 and the home address of the MN 10. The source address field 301 and the destination address field 303 may be IPv6 or IPv4 addresses.

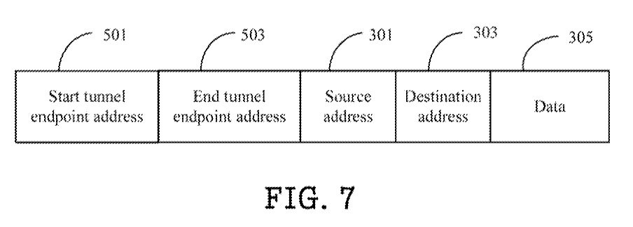

FIG. 7 is a schematic diagram of an encapsulated message of an exemplary embodiment of the present invention. In the exemplary embodiment, the encapsulated message may be an encapsulated address conversion request message, an encapsulated address conversion response message, or an encapsulated origination message. The message shown in FIG. 6 is encapsulated in an IPv4 tunnel or an IPv6 tunnel and consequently becomes the encapsulated message shown in FIG. 7. A start tunnel endpoint address field 501 and an end tunnel endpoint address field 503 of the encapsulated message respectively indicate a start tunnel endpoint address and an end tunnel endpoint address of the tunnel in which the encapsulated message is encapsulated. If the message of FIG. 6 is encapsulated in the IPv4 tunnel, the start tunnel endpoint address field 501 and the end tunnel endpoint address field 503 are both set as IPv4 addresses. If the message of FIG. 6 is encapsulated in the IPv6 tunnel, the start tunnel endpoint address field 501 and the end tunnel endpoint address field 503 of the encapsulated message are both set as IPv6 addresses.

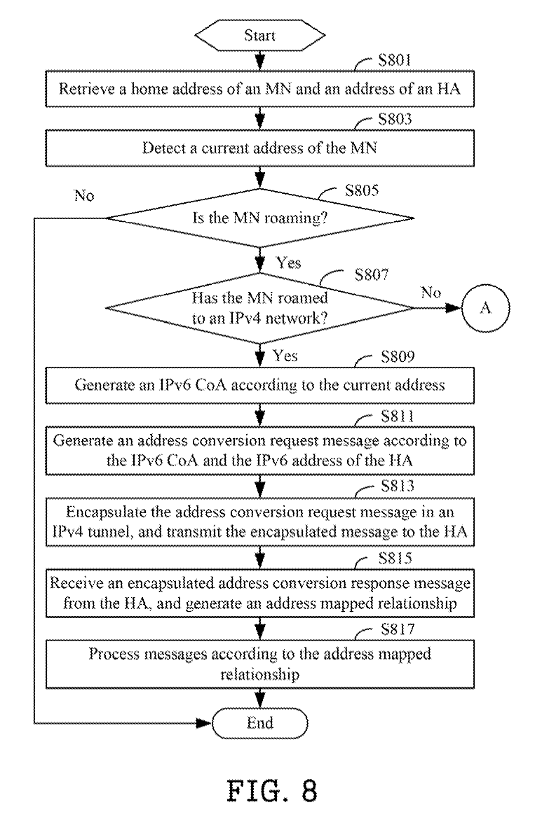

FIG. 8 is a flowchart of a network roaming method of an exemplary embodiment of the present invention.

In step S801, the address detection module 101 retrieves the home address of the MN 10 and the address of the HA 20. In the exemplary embodiment, the address of the HA 20 includes an IPv4 address and an IPv6 address.

In step S803, the address detection module 101 detects a current address of the MN 10.

In step S805, the address detection module 101 determines whether the MN 10 is roaming. In the exemplary embodiment, the address detection module 101 checks whether the current address of the MN 10 is the same as the home address of the MN 10, to determine whether the MN 10 is roaming. If the current address of the MN 10 is different from the home address of the MN 10, the MN 10 is roaming. If the current address of the MN 10 is the same as the home address of the MN 10, the MN 10 is not roaming.

If the MN 10 is roaming, in step S807, the address detection module 101 determines whether the MN 10 has roamed to an IPv4 network. In the exemplary embodiment, if the current address of the MN 10 is an IPv4 address, the address detection module 101 determines that the MN 10 has roamed to an IPv4 network. If the current address of the MN 10 is an IPv6 address, the address detection module 10 determines that the MN 10 has roamed to an IPv6 network.

If the MN 10 has not roamed to an IPv4 network, the process goes to a node A.

If the MN has roamed to an IPv4 network, in step S809, the address generating module 103 generates an IPv6 CoA of the MN 10 according to the current address of the mobile node 10, by use of an address conversion mechanism. In the exemplary embodiment, the address conversion mechanism may be a 6 to 4 automatic tunnel mechanism or an NAT-PT mechanism.

In step S811, the address conversion request module 107 generates the address conversion request message 1000 (shown in FIG. 4). Referring also to FIG. 6, the source address field 301 of the address conversion request message 1000 is set as the IPv6 CoA of the MN 10, and the destination address field 303 of the address conversion request message 1000 is set as the IPv6 address of the HA 20.

In step S813, the address conversion request module 107 encapsulates the address conversion request message 1000 in an IPv4 tunnel to produce an encapsulated address conversion request message 1001 (shown in FIG. 4), and transmits the encapsulated address conversion request message 1001 to the HA 20. Referring also to FIG. 7, the start tunnel endpoint address field 501 of the IPv4 tunnel is set as the IPv4 CoA of the MN 10, and the end tunnel endpoint address field 503 of the IPv4 tunnel is set as the IPv4 address of the HA 20.

In step S815, the address conversion request module 107 receives the encapsulated address conversion response message 2001 from the HA 20, and generates an address mapping relationship between the home address and the IPv4 CoA of the MN 10 according to the encapsulated address conversion response message 2001.

In step S817, the processing module 111 processes messages according to the address mapping relationship generated by the address conversion request module 107.

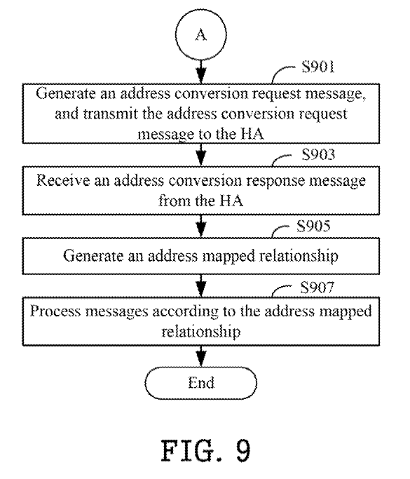

FIG. 9 is a flowchart after the node A of FIG. 8.

Referring also to FIG. 3, if the mobile node 10 roams to an IPv6 network, in step S901, the address conversion request module 107 generates the address conversion request message 1000a, and transmits the address conversion request message 1000a to the HA 20. Referring also to FIG. 6, the source address field 301 of the address conversion request message 1000a is set as the current address of the mobile node 10, namely the IPv6 CoA of the MN 10, and the destination address field 303 of the address conversion request message 1000a is set as the IPv6 address of the HA 20.

In step S903, the address conversion request module 107 receives the address conversion response message 2000a from the HA 20.

In step S905, the address conversion request module generates an address mapping relationship between the current address and the home address of the MN 10 according to the address conversion response message 2000a.

In step S907, the processing module 111 processes messages according to the address mapping relationship.

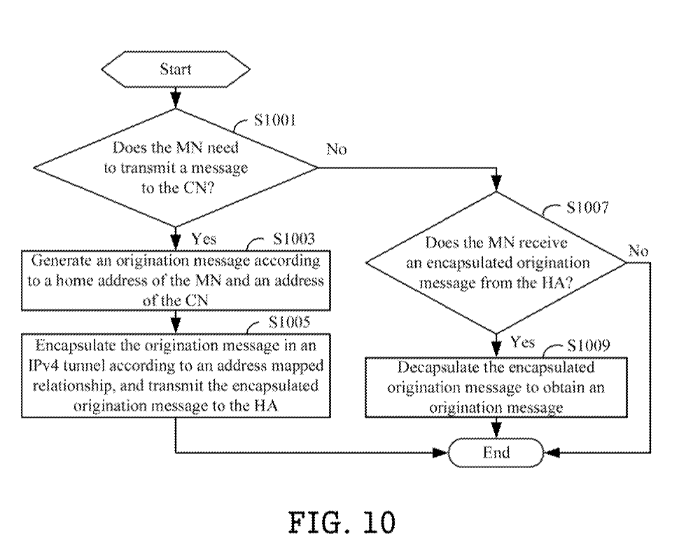

FIG. 10 is a detailed flowchart of step S817 of FIG. 8 when the foreign network is an IPv4 network.

Referring also to FIG. 4, in step S1001, the processing module 111 determines whether the MN 10 needs to transmit a message to the CN 30.

If the MN 10 needs to transmit a message to the CN 30, in step S1003, the message producing module 109 generates an origination message 4003. Referring also to FIG. 6, the message producing module 109 sets the source address field 301 of the origination message 4003 as the home address of the MN 10, and the destination address field 303 of the origination message 4003 as the address of the CN 30.

In step S1005, the processing module 111 encapsulates the origination message 4003 in an IPv4 tunnel according to the address mapping relationship to produce an encapsulated origination message 3003, and transmits the encapsulated origination message 3003 to the HA 20. Referring also to FIG. 7, the start tunnel endpoint address field 501 of the IPv4 tunnel is set as the IPv4 CoA of the MN 10 detected by the address detection module 101, and the end tunnel endpoint address field 503 of the IPv4 tunnel is set as the IPv4 address of the HA 20.

If the MN 10 does not need to transmit a message to the CN 30, in step S1007, the processing module 111 determines whether the MN 10 receives an encapsulated origination message 3001 from the HA 20.

If the MN 10 receives the encapsulated origination message 3001 from the HA 20, in step S1009, the processing module 111 decapsulates the encapsulated origination message 3001 according to the address mapping relationship to obtain the origination message 4001.

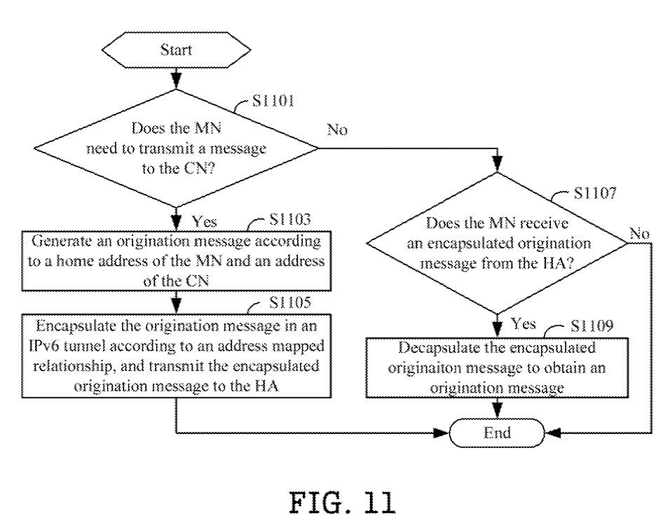

FIG. 11 is a detailed flowchart of step S907 of FIG. 9 when the foreign network is an IPv6 network.

Referring also to FIG. 3, in step S1101, the processing module 113 determines whether the MN 10 needs to transmit a message to the CN 30.

If the MN 10 needs to transmit a message to the CN 30, in step S1103, the producing module 111 generates an origination message 4003a. Referring also to FIG. 6, the message producing module 109 sets the source address field 301 of the origination message 4003a as the home address of the MN 10, and the destination address field 303 of the origination message 4003a as the address of the CN 30.

In step S1105, the processing module 111 encapsulates the origination message 4003a in an IPv6 tunnel according to the address mapping relationship to produce an encapsulated origination message 3003a, and transmits the encapsulated origination message 3003a to the HA 20. Referring also to FIG. 7, the start tunnel endpoint address field 501 of the IPv6 tunnel is set as the IPv6 CoA of the MN 10 detected by the address detection module 101, and the end tunnel endpoint address field 503 of the IPv6 tunnel is set as the IPv6 address of the HA 20.

If the MN 10 does not need to transmit a message to the CN 10, in step S1107, the processing module 111 determines whether the MN 10 receives an encapsulated origination message 3001a from the HA 20.

If the MN 10 receives the encapsulated origination message 3001a from the HA 20, in step S1109, the processing module 111 decapsulates the encapsulated origination message 3001a according to the address mapping relationship to obtain the origination message 4001a.

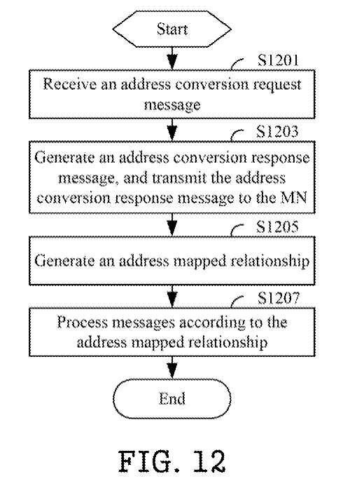

FIG. 12 is a flowchart showing a method for forwarding messages by the HA 20 of an exemplary embodiment of the present invention.

In step S1201, the address conversion response module 203 receives an address conversion request message from the MN 10.

In step S1203, the address conversion response module 203 generates an address conversion response message according to the address conversion request message, and transmits the address conversion response message to the MN 10.

In step S1205, the address conversion response module 203 generates an address mapping relationship according to the address conversion request message.

In step S1207, the message processing module 205 processes messages according to the address mapping relationship.

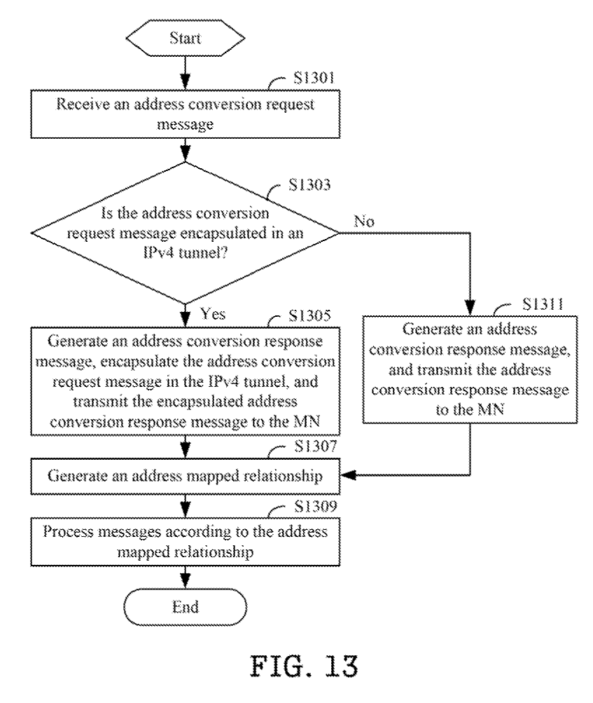

FIG. 13 is a detailed flowchart of the method of FIG. 12.

In step S1301, the address conversion response module 203 receives an address conversion request message from the MN 10.

In step S1303, the address conversion response module 203 determines whether the address conversion request message is encapsulated in an IPv4 tunnel.

If the address conversion request message is encapsulated in an IPv4 tunnel, in step S1305, the address conversion response module 203 generates an address conversion response message, and encapsulates the address conversion response message in the IPv4 tunnel according to the address conversion request message, and then transmits the encapsulated address conversion response message to the MN 10.

In step S1307, the address conversion response module 203 generates an address mapping relationship between the current address of the MN 10 and the home address of the MN 10 according to the address conversion request message. In the exemplary embodiment, the current address of the MN 10 may be an IPv4 address or an IPv6 address.

In step S1309, the message processing module 205 processes messages according to the address mapping relationship.

In step S1303, if the address conversion request message is not encapsulated in an IPv4 tunnel, in step S1311, the address conversion response module 203 generates an address conversion response message, and transmits the address conversion response message to the MN 10. Then the process goes to step S1307 that has been described in the above text.

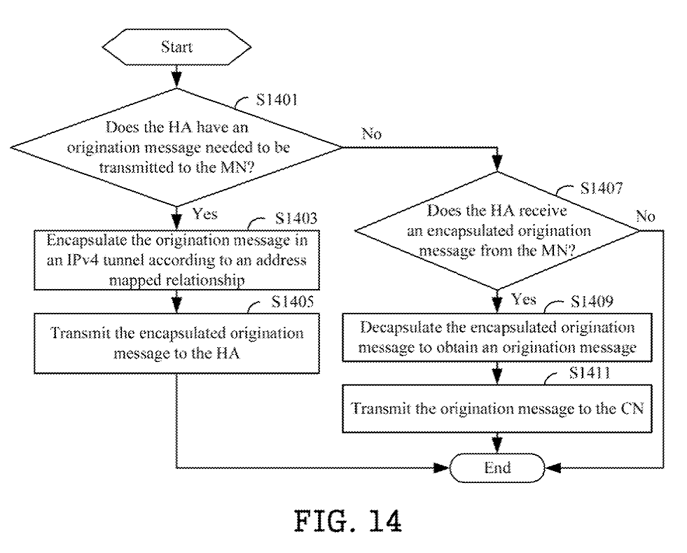

FIG. 14 is a detailed flowchart of step S1309 of FIG. 13 when the foreign network is an IPv4 network.

Referring also to FIG. 4, in step S1401, the message processing module 205 determines whether the HA 20 has an origination message 4001 needed to be transmitted to the MN 20. In the exemplary embodiment, the origination message 4001 is destined for the MN 10, and the message processing module 205 receives the origination message 4001 from the CN 30.

If the HA 20 has the origination message 4001 needed to be transmitted to the MN 20, in step S1403, the message processing module 205 encapsulates the origination message 4001 in an IPv4 tunnel to produce an encapsulated origination message 3001. In the exemplary embodiment, the IPv4 tunnel is the same as the IPv4 tunnel in which the address conversion response message is encapsulated.

In step S1405, the message processing module 205 transmits the encapsulated origination message 3001 to the MN 10.

If the HA 20 does not have an origination message needed to be transmitted to the MN 10, in step S1407, the message processing module 205 determines whether the HA 20 receives an encapsulated origination message 3003 destined for the CN 30 from the MN 10.

If the HA 20 receives the encapsulated origination message 3003 from the MN 10, in step S1409, the message processing module 205 decapsulates the encapsulated origination message 3003 according to the address mapping relationship generated by the address conversion response module 205 to obtain the origination message 4003.

In step S1411, the message processing module 205 transmits the origination message 4003 to the CN 30.

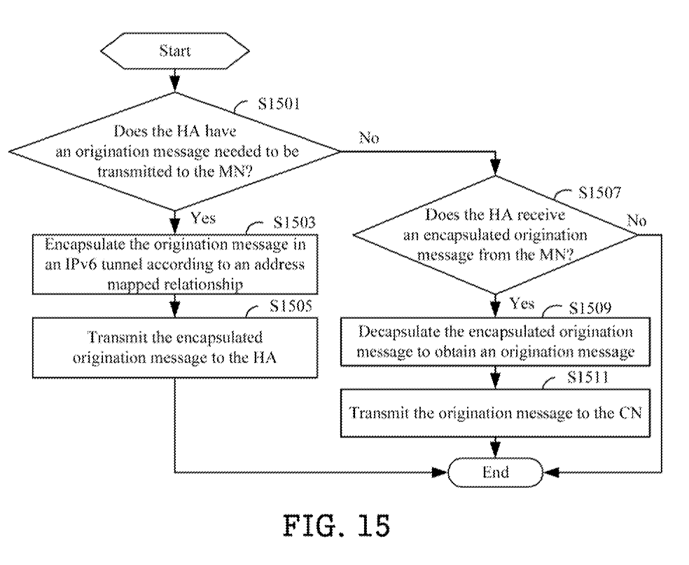

FIG. 15 is a detailed flowchart of step S1309 of FIG. 13 when the foreign network is an IPv6 network.

Referring also to FIG. 3, in step S1501, the message processing module 205 determines whether the HA 20 has an origination message 4001a needed to be transmitted to the MN 10.

If the HA 20 has the origination message 4001a needed to be transmitted to the MN 10, in step S1503, the message processing module 205 encapsulates the origination message 4001a in an IPv6 tunnel to produce the encapsulated origination message 3001a. Referring also to FIG. 7, the start tunnel endpoint address field 501 and the end tunnel endpoint address field 503 are respectively set as the IPv6 address of the HA 20 and the IPv6 CoA of the MN 10.

In step S1505, the message processing module 205 transmits the encapsulated origination message 3001a to the MN 10.

If the HA 20 has no message needed to be transmitted to the MN 10, in step S1507, the message processing module determines whether the HA 20 receives an encapsulated origination message destined for the CN 30 from the MN 10.

If the HA 20 receives the encapsulated origination message 3003a from the MN 10, in step S1509, the message processing module 205 decapsulates the encapsulated origination message 3003a according to the address mapping relationship to obtain the origination message 4003a.

In step S1511, the message processing module 205 transmits the origination message 4003a to the CN 30.

Thus, the MN 10 can roam between IPv4 and IPv6 networks, and maintain communication with the CN 30.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A mobile node adapted for roaming from a home network to a foreign network, the mobile node comprising:
an address detection module for detecting a current address of the mobile node; and
an address conversion request module for transmitting an address conversion request message to the home agent according to the current address of the mobile node and an address of the home agent, receiving an address conversion response message from the home agent, and generating an address mapping relationship between a home address and the current address of the mobile node according to the address conversion response message.

2. The mobile node as claimed in claim 1, further comprising a storage module for storing the home address of the mobile node and the address of the home agent, wherein the address of the home agent comprises an IPv4 (Internet protocol version 4) address and an IPv6 (Internet protocol version 6) address.

3. The mobile node as claimed in claim 2, wherein the foreign network is an IPv4 network, and the current address of the mobile node is an IPv4 care-of address (CoA).

4. The mobile node as claimed in claim 3, further comprising an address generating module for generating an IPv6 CoA of the mobile node according to the current address of the mobile node when the mobile node roams to the IPv4 network.

5. The mobile node as claimed in claim 4, wherein the address conversion request module is used for generating the address conversion request message according to the IPv6 CoA of the mobile node and the IPv6 address of the home agent, encapsulating the address conversion request message in an IPv4 tunnel with endpoints of the IPv4 CoA of the mobile node and the IPv4 address of the home agent, and transmitting the encapsulated address conversion request message to the home agent.

6. The mobile node as claimed in claim 5, further comprising a message producing module for producing an origination message.

7. The mobile node as claimed in claim 6, further comprising a processing module for encapsulating the origination message in the IPv4 tunnel with endpoints of the IPv4 CoA of the mobile node and the IPv4 address of the home agent according to the address mapping relationship, and transmitting the encapsulated origination message to the home agent.

8. The mobile node as claimed in claim 7, wherein the processing module is further used for receiving an encapsulated origination message from the home agent, and decapsulating the encapsulated origination message to obtain an origination message according to the address mapping relationship.

9. The mobile node as claimed in claim 2, wherein the foreign network is an IPv6 network, and the current address of the mobile node is an IPv6 CoA.

10. The mobile node as claimed in claim 9, wherein the address conversion request module is used for generating the address conversion request message according to the IPv6 CoA of the mobile node and the IPv6 address of the home agent, and transmitting the address conversion request message to the home agent.

11. The mobile node as claimed in claim 10, further comprising a message producing module for producing an origination message.

12. The mobile node as claimed in claim 11, further comprising a processing module for encapsulating the origination message in an IPv6 tunnel with endpoints of the IPv6 CoA of the mobile node and the IPv6 address of the home agent according to the address mapping relationship, and transmitting the encapsulated origination message to the home agent.

13. The mobile node as claimed in claim 12, wherein the processing module is further used for receiving an encapsulated origination message from the home agent, and decapsulating the encapsulated origination message to obtain an origination message according to the address mapping relationship.

14. A network system comprising a home agent and a mobile node, wherein:
the mobile node is adapted for roaming from a home network to a foreign network, and comprises:
an address detection module for detecting a current address of the mobile node; and
an address conversion request module for transmitting an address conversion request message to a home agent according to the current address of the mobile node and an address of the home agent, receiving an address conversion response message from the home agent, and generating an address mapping relationship between a home address and the current address of the mobile node;
the home agent comprises an address conversion response module for receiving the address request message from the mobile node, transmitting the address conversion response message to the mobile node, and generating the address mapping relationship between the home address and the current address of the mobile node according to the address conversion request message.

15. The network system as claimed in claim 14, wherein:
the mobile node further comprises a storage module for storing the home address of the mobile node and the address of the home agent, wherein the address of the home agent comprises an IPv4 (Internet protocol version 4) address and an IPv6 (Internet protocol version 6) address;
the home agent further comprises a data saving module for saving the address of the home agent.

16. The network system as claimed in claim 15, wherein the foreign network is an IPv4 network, and the current address of the mobile node is an IPv4 CoA.

17. The network system as claimed in claim 16, wherein the mobile node further comprises an address generating module for generating an IPv6 CoA of the mobile node according to the current address of the mobile node.

18. The network system as claimed in claim 17, wherein:
the address conversion request module is used for generating the address conversion request message according to the generated IPv6 CoA of the mobile node and the IPv6 address of the home agent, encapsulating the address conversion request message in an IPv4 tunnel with endpoints of the IPv4 CoA of the mobile node and the IPv4 address of the home agent, and transmitting the encapsulated address conversion request message to the home agent;
the address conversion response module is used for encapsulating the address conversion response message in the IPv4 tunnel with the endpoints of the IPv4 CoA of the mobile node and the IPv4 address of the home agent, and transmitting the encapsulated address conversion response message to the mobile node.

19. The network system as claimed in claim 18, wherein the mobile node further comprises a message producing module for producing an origination message.

20. The network system as claimed in claim 19, wherein the mobile node further comprises a processing module for encapsulating the origination message in the IPv4 tunnel with endpoints of the IPv4 CoA of the mobile node and the IPv4 address of the home agent according to the address mapping relationship, and transmitting the encapsulated origination message to the home agent, and also for receiving an encapsulated origination message from the home agent, and decapsulating the encapsulated origination message to obtain an origination message according to the address mapping relationship.

21. The network system as claimed in claim 18, wherein the home agent further comprises a message processing module for receiving an origination message destined for the mobile node from a correspondent node, and encapsulating the origination message in the IPv4 tunnel with endpoints of the IPv4 CoA of the mobile node and the IPv4 address of the home agent according to the address mapping relationship.

22. The network system as claimed in claim 21, wherein the message processing module is further used for transmitting the encapsulated origination message to the mobile node, and also for receiving an encapsulated origination message destined for a correspondent node from the mobile node, decapsulating the encapsulated origination message to obtain an origination message according to the address mapping relationship, and transmitting the origination message to the correspondent node.

23. The network system as claimed in claim 15, wherein the foreign network is an IPv6 network, and the current address of the mobile node is an IPv6 CoA.

24. The network system as claimed in claim 23, wherein the address conversion request module is used for generating the address conversion request message according to the IPv6 CoA of the mobile node and the IPv6 address of the home agent, and transmitting the address conversion request message to the home agent.

25. The network system as claimed in claim 24, wherein the mobile node further comprises a message producing module for producing an origination message.

26. The network system as claimed in claim 25, wherein the mobile node further comprises a processing module for encapsulating the origination message in the IPv6 tunnel with endpoints of the IPv6 CoA of the mobile node and the IPv6 address of the home agent according to the address mapping relationship.

27. The network system as claimed in claim 26, wherein the processing module is further used for transmitting the encapsulated origination message to the home agent, and also for receiving an encapsulated origination message from the home agent, and decapsulating the encapsulated origination message to obtain an origination message according to the address mapping relationship.

28. The network system as claimed in claim 24, wherein the home agent further comprises a message processing module for receiving an origination message destined for the mobile node from a correspondent node, and encapsulating the origination message in the IPv6 tunnel with endpoints of the IPv6 CoA of the mobile node and the IPv6 address of the home agent according to the address mapping relationship.

29. The network system as claimed in claim 28, wherein message processing module is further used for transmitting the encapsulated origination message to the mobile node, and also for receiving an encapsulated origination message destined for a correspondent node from the mobile node, decapsulating the encapsulated origination message to obtain an origination message according to the address mapping relationship, and transmitting the origination message to the correspondent node.

30. A network roaming method for a mobile node roaming from a home network to a foreign network, comprising the steps of:
detecting a current address of the mobile node;
transmitting an address conversion request message from the mobile node to a home agent according to the current address of the mobile node and an address of the home agent;
receiving an address conversion response message from the home agent; and
generating an address mapping relationship between a home address and the current address of the mobile node according to the address conversion response message.

31. The network roaming method as claimed in claim 30, further comprising the step of:
processing messages according to the address mapping relationship.

32. The network roaming method as claimed in claim 31, further comprising the steps of:
determining whether the mobile node roams to an IPv4 (Internet protocol version 4) network;
generating an IPv6 (Internet protocol version 6) CoA of the mobile node according to the current address of the mobile node if the mobile node roams to an IPv4 network;
generating the address conversion request message according to the IPv6 CoA of the mobile node and an IPv6 address of the home agent;
encapsulating the address conversion request message in an IPv4 tunnel with endpoints of an IPv4 CoA of the mobile node and an IPv4 address of the home agent; and
transmitting the encapsulated address conversion request message to the home agent.

33. The network roaming method as claimed in claim 32, wherein processing messages according to the address mapping relationship comprises:
generating an origination message;
encapsulating the origination message in an IPv4 tunnel with endpoints of the IPv4 CoA of the mobile node and the IPv4 address of the home agent according to the address mapping relationship; and
transmitting the encapsulated origination message to the home agent.

34. The network roaming method as claimed in claim 32, further comprising:
generating the address conversion request message according to an IPv6 CoA of the mobile node and the IPv6 address of the home agent if the mobile node roams to an IPv6 network; and
transmitting the address conversion request message to the home agent.

35. The network roaming method as claimed in claim 34, wherein processing messages according to the address mapping relationship comprises:
generating an origination message;
encapsulating the origination message in an IPv6 tunnel with endpoints of the IPv6 CoA of the mobile node and the IPv6 address of the home agent according to the address mapping relationship;
transmitting the encapsulated origination message to the home agent.
